(19) United States
(12) Patent Application Publication
(10) Pub. No.: US 2011/0059664 A1
(43) Pub. Date: Mar. 10, 2011

(54) ROLLING MEMBER

(76) Inventor: Thierry Poichot, Brindas (FR)

(21) Appl. No.: 12/865,093

(22) PCT Filed: Jan. 30, 2009
(86) PCT No.: PCT/FR2009/050138

§ 371 Date: Nov. 10, 2010

(30) Foreign Application Priority Data
Jan. 31, 2008 (FR) 08/00536

(51) Int. Cl. A63C 17/10; B62D 55/08; B62D 55/00; B62D 55/24; B63B 35/79; A63C 17/14

(52) U.S. Cl. 441/74; 305/165; 305/9; 280/844

(57) ABSTRACT

Rolling member comprising a track (2) and a moving part (1) able to move relative to the track (2) and designed to form a rolling strip (10) travelling in a closed circuit, said member being characterized in that the moving part (1) comprises a flexible and continuous movement bead, and the track (2) is designed to guide the moving part (1) along a skew path of variable curvature.

### TECHNICAL FIELD

The present invention concerns a rolling member, as well as individual athletic, leisure or movement equipment or a vehicle equipped with such a rolling member.

### BACKGROUND

The most commonly used rolling member is the wheel. In theory, the contact of a wheel with the ground is a tangent line, the length of which corresponds to the width of the rolling strip. This is the case for carriage wheels on rails as shown in FIG. 1a.

The discovery of rubber made it possible to provide the flexible tire, making it possible to increase the contact surface by crushing of that tire in contact with the ground as shown in FIG. 1b.

Then the invention of the tire and the successive improvements of tires made it possible to optimize the lateral rigidity and deformation capacity of said tire, thereby increasing the ground contact surface as shown in FIG. 1c.

To increase the contact surface between a wheel and the ground, it is possible to broaden the rolling strip, increase the diameter of the wheel, or increase the capacity of the tire to deform, in particular by using more flexible materials and/or materials with lower air pressure.

During the movement, ground irregularities, holes, bumps or any obstacle encountered by the wheel generates an impact, and therefore stresses that are transmitted to the running gear and the moving equipment.

These stresses can be broken down along the three axes:
Vertical, corresponding to gravity,
Longitudinal, corresponding to the direction of travel,
Lateral, corresponding to the lateral and centripetal components.

These components are directly proportional to the weight, and to the square of the speed of the moving equipment.

They are directly related to the grading of the support, the size of the irregularities and obstacles, the incidence angle of the impact with the wheel, and the damping capacity of the tire and running gear.

They cause reaction forces that also depend on the inertia of the moving elements of the same running gear.

The longitudinal component opposes the movement, generating a waste of energy.

The vertical component directly impacts the comfort of the moving equipment, and it causes the ground contact pressure to vary, and can go so far as to cancel it, causing a partial or total lack of adhesion.

The lateral component influences the travel path, in particular at a steering wheel.

To reduce these parasitic stresses, it is possible to reduce the incidence angle with the irregularities, by increasing the diameter of the wheel, to increase the capacity of the tire to deform, in particular by using more flexible materials and/or lower air pressure, to develop tire structures and profiles that limit the lateral components, or to reduce the mass of the wheel, and of the moving elements of the running gear.

Furthermore, the movement of the wheel on the ground causes frictional forces that are proportional to the contact surface, and to the deformation strains of the rolling strip.

The movement of the wheel causes an aerodynamic drag proportional to its wing area and to the square of the displacement speed.

The rotation of the wheel grants it an inertial energy directly proportional to its inertial moment, and to the square of its speed of rotation, expressed in radians per second.

The displacement of the moving equipment grants it a kinetic energy directly proportional to its mass and to the square of its speed. This kinetic energy is the sum of the kinetic energies of each of the components of the equipment.

The sole integration of the non-exhaustive basic parameters listed above involves compromises, and each usage context involves different compromises.

For example, to reduce the ground contact pressure, increase adhesion, reduce the impact of ground irregularities and improve the capacity to overcome obstacles, the wheels of all-terrain vehicles are over-dimensioned; they are therefore heavier and the mechanical strength of all of the components must be increased.

This increase in size translates not only to increased bulk, friction, and aerodynamic drag, but also to increased mass, inertia and potential kinetic energy.

This therefore means heavier, more costly vehicles consuming more energy, for less favorable performance and comfort.

In some cases, it is desirable to have rolling members that do not have a circular shape like a wheel, but a profile adapted to a specific application.

In particular, it is known from document FR571503 to provide a rolling member of non-circular shape in order in particular to reduce the shocks caused by protrusions on the ground.

### BRIEF SUMMARY

It appears desirable to provide a rolling member of the aforementioned type making it possible to pursue all or part of the following:
improve behavior and comfort on all types of terrain,
allow use on a wide variety of terrains,
allow a low and stable position of the object or person supported by the rolling member,
keep a weight, bulk and cost comparable to the existing products.

To that end, the present invention concerns a rolling member comprising a track guide and a moving part able to move relative to the track guide and designed to form a rolling strip moving in a closed circuit, characterized in that the moving part comprises a flexible and continuous movement bead, and the track guide is designed to guide the moving part along a skew path of variable curvature.

The rolling member according to the invention behaves in part like a wheel, i.e. the moving part, which we call movement bead, goes without friction on the ground, while driving, guiding and supporting the vehicle and/or the person equipped with it.

The moving part goes along a closed track guide that is not circular or even comprised in a plane. Indeed, the shape, dimensions and choice of materials making up the movement bead grant it torsion and flexion characteristics allowing it to follow, by elastic deformation, a closed curved skew path of variable curvature imposed on it by the track guide.

It is designed so that the deformations thus imposed on it remain in the framework of its elastic limits, so that its movement absorbs a minimal amount of energy.

These arrangements make it possible to have an increased ground contact zone. They also make it possible to:

give the attack zone of the wheel a wide variety of paths, depending on the usage conditions.

give the inactive part of the wheel a path that is integrated into the dimensional imperatives of the equipped vehicle.

damp the irregularities of the support by elastic deformation of all or part of the wheel.

Advantageously, the member comprises revolution rolling members arranged between a rolling surface of the moving part and the track guide so as to facilitate the relative movement between the track guide and the moving part.

According to one embodiment, the movement bead is made of an elastic material.

Advantageously, the bead can have, inside, a core in a softer material, even a foam, or a void filled with a pressurized gas.

According to one embodiment, the bead comprises several elements made up of different attached materials in order to obtain different mechanical properties for the rolling strip, the rolling surface and the core.

Advantageously, the bead has cavities facing the inside of the path designed to cooperate with means intended to restrict the movement in a single direction.

According to one embodiment, the member comprises braking means cooperating with the movement bead.

Advantageously, the bead comprises at least two rolling surfaces between which a flexible center is arranged so as to provide the rigidity necessary for the transmission of the guiding and maintenance stresses of the movement bead.

According to one possibility, the track guide includes raceways making it possible to guide the movement of the rolling element, the movement bead comprises one or several rolling surfaces, the rolling elements thus being housed between the rolling surface of the movement bead and the raceway.

According to another possibility, the rolling elements comprise a certain number of rollers whereof the axis of rotation is integral with the track guide, the movement bead comprising one or several rolling surfaces on which the rolling elements bear.

Advantageously, the track guide is arranged such that the bead has several distinct contact zones with the movement surface.

The present invention also concerns individual movement, athletic or leisure equipment or skate comprising a rolling member as previous described.

Advantageously, the equipment is provided with a footrest plate designed to receive both feet of the skater, who uses it as a skateboard, snowboard or surfboard.

The present invention also concerns equipment for any use of a nature to allow or facilitate the movement of people or goods comprising a rolling member according to the invention or a land, air or water vehicle comprising such a rolling member.

### BRIEF DESCRIPTION OF THE DRAWINGS

The invention will be better understood using the detailed description provided below in light of the appended drawing, in which:

FIG. 1a is a diagram illustrating the contact zones between a wheel and flat ground.

FIG. 1b is a diagram illustrating the contact zones between a wheel provided with a tire and flat ground.

FIG. 1c is a diagram illustrating the contact zones between a wheel provided with a tire and flat ground.

FIG. 2 is a side view of the inside of the skater's right leg of a movement skate comprising a first embodiment of a rolling member according to the invention.

FIG. 3 is a rear view of the movement skate of FIG. 2.

FIGS. 4a, 4b, 5 and 6 show the cross-sectional view of a rolling member according to different embodiments.

FIG. 7 is a diagrammatic view illustrating the profile of a moving part of a rolling member according to the invention according to one alternative of the invention.

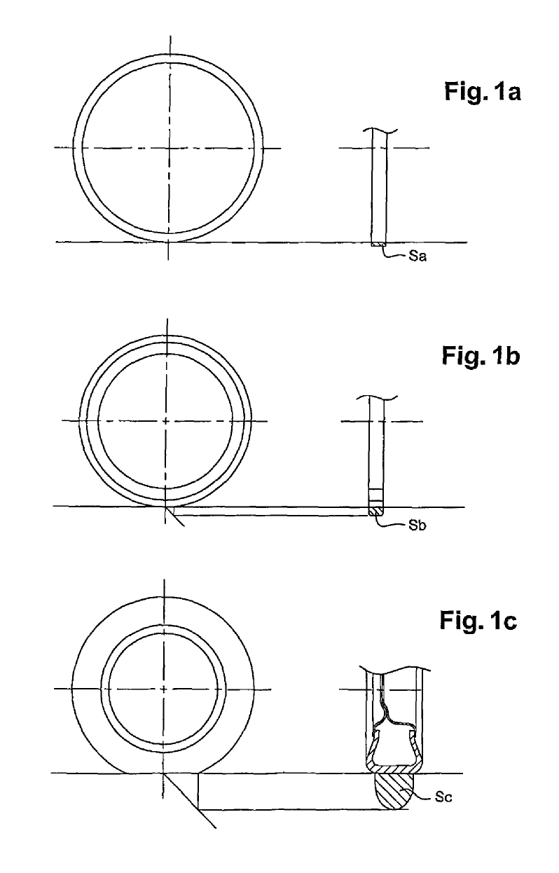

### DETAILED DESCRIPTION

As illustrated in the figures, a rolling member according to the invention includes:

a moving part 1 comprising a flexible movement bead forming a closed curve that goes on a movement surface, for example a ground, such as a tire or a caterpillar track guide,

a track guide 2 of the moving part designed to guide it on a skew path of variable curvature.

The rolling member also comprises revolution rolling elements 5 arranged between the moving part 1 and the track guide 2 so as to ensure a movement with limited friction between those two parts of the member.

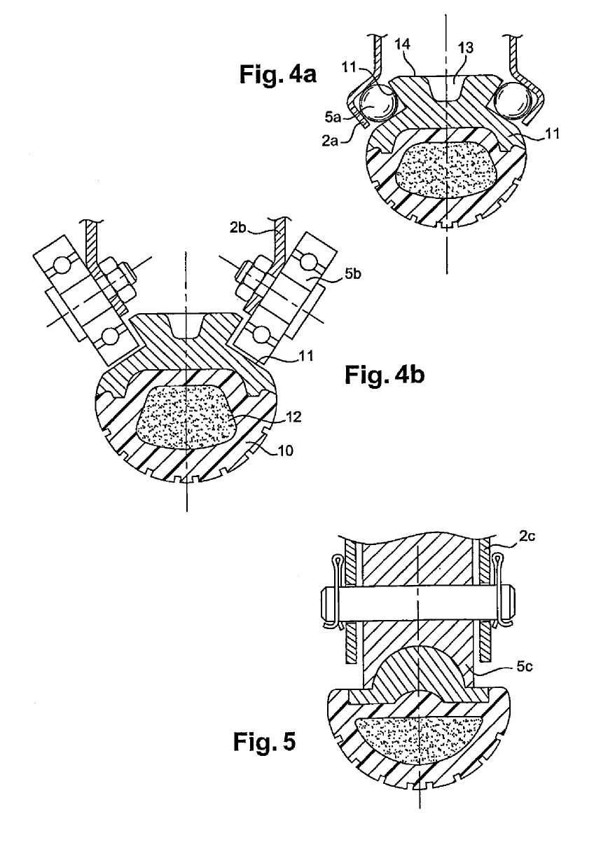

According to a first embodiment illustrated in FIG. 4, the movement bead comprises, on a part facing the outside of the path and designed to be in contact with the movement surface, a rolling strip 10.

This rolling strip has a profile and tread designs that can be adapted depending on the type of movement surface chosen.

The bead comprises a part positioned toward the inside of the path of the bead comprising rolling surfaces 11 on which the rolling elements 5 will roll, hard enough for the rolling stress to be minimal.

The bead can have, inside, a core 12 in a softer material, even a foam, or a void filled with a pressurized gas.

These arrangements make it possible to produce a connection between the rolling strip 10 and the rolling surfaces 11, which reconciles a slight lateral deformation of the bead, and a good damping capacity.

It is possible to provide a bead made up of several elements made up of different associated materials in order to obtain the desired properties for the rolling strip, the rolling surfaces 11, the core 12, the bead body, any other functional entity, and their connection.

The bead can also have cavities 13 facing the inside of the path making it possible to drive a toothed wheel, that can be provided with a freewheel hub, to prohibit backwards movement, in particular on ascents, that may be disconnected as needed and that can also have, optionally, the brake disc function.

A surface 14, preferably facing the inside of the path, can optionally be used as brake drum.

This surface 14 can also be used to form a backstop system by jamming rolls facing inclined surfaces, or by jamming eccentric surfaces, which may also be disconnected as needed.

The shape of the movement bead 1 is imposed by the track guide 2 via rolling elements 5, allowing a movement of the rolling bead without friction.

Before its mounting between, on or around the track guide, it may be presented as a circular flexible ring, resembling a tire, the development of which corresponds to that defined by these track guides. This allows it to have a radius of curvature at rest corresponding as well as possible to the average of the radii of curvature described during its movement.

It may also look at rest like a rectilinear element, possibly less costly to manufacture, that will be closed and fastened on itself in a ring, before, during or after its integration with the track guide.

The track guide 2 is machined and formed according to the desired displacement journey of the movement bead.

According to a first possibility shown in FIG. 4a, the track guide 2 includes raceways 2a making it possible to guide the movement of the rolling element, in particular of the ball bearing type 5a.

Each rolling element 5a is thus housed between the rolling surface 11 of the movement bead and the raceway 2a.

According to another possibility shown in FIG. 4b and FIG. 5, the track guide can also comprise means for fastening rolling elements made up of at least one roller 5b. The pivot of the roller is integral with the track guide, and the roller rolls on the rolling surface 11 of the movement bead.

The support zones of the rolling elements on the movement bead are arranged so as to guide the movement thereof and avoid lateral movements.

Thus, it is possible to provide two rolling surfaces 11 inclined on either side of the bead as shown in FIG. 5.

It is also possible to provide a single rolling surface 11 of convex or concave shape making it possible to ensure the guiding by complementarity of shape with the rolling elements 5a.

The track guide 2 and the rolling elements 5 ensure lateral guiding, the different inflections of the path of the bead, the radial guiding allowing the rolling on the movement surface, and retention to prevent the bead from escaping (“demounting”), or its stress.

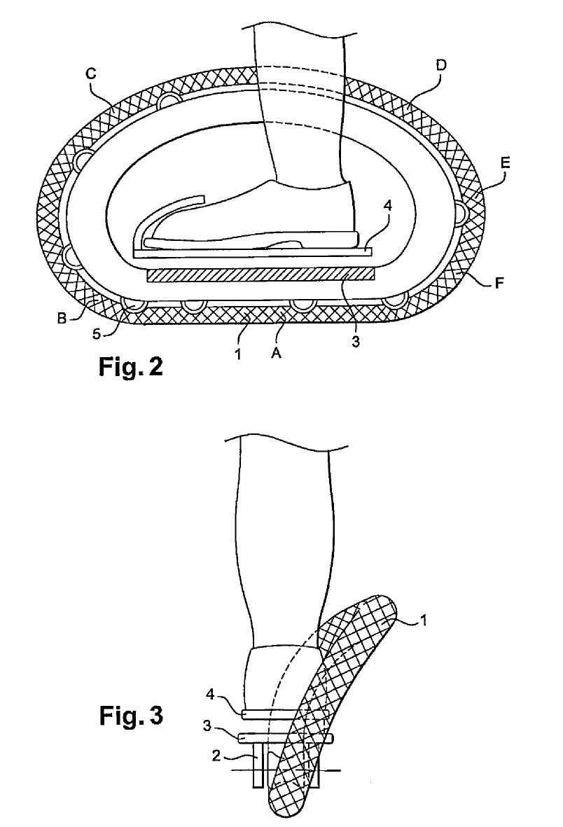

The materials chosen for the movement bead allow it the elasticity necessary to follow the skew ovoid displacement journey illustrated in FIGS. 2 and 3 elastically; by freeing itself, it therefore restores all or part of the energy consumed for its deformation.

This rolling member is particularly adapted to roller skates:

A skate equipped with a rolling member according to the invention comprises a boot 4 designed to hold the skater's foot or shoe.

The boot can be made up of a shoe that the skater laces or locks around his foot such as an ice skate according to a first alternative, or can include fastenings making it possible to practice with special shoes, such as cross-country ski shoes, or mountain boots, for example, according to a second alternative illustrated in FIGS. 2 and 3.

The natural stability of the equipment makes it possible to propose simple, quick and effective fastening systems, compatible with the majority of town and sport shoes, as was the case for previous generations of roller skates.

The boot is fastened on a frame 3 whereon a rolling member as previously described is fastened.

The path of the movement bead 1 can comprise 6 main distinct zones:

1) the contact zone A with the ground is rectilinear or has a large radius of curvature under the skater's foot, in the vertical plane, and over a more or less significant length to favor the stability, workability or speed;

2) the attack zone B in front of the foot rises with an adapted profile, so as to mount obstacles and irregularities encountered on its path;

3) the recess zone C above the front of the foot curves toward the outside of the skater's body, so as to return toward the rear of the skate while avoiding the skater's calf;

4) the lateral zone D can leave freedom of path of the bead so that it can compensate for the evolute variations due to the expansion, wear or aging of the material;

5) the return zone E behind the skater's foot that imposes a path approximately symmetrical to zone 3;

6) the rear support zone F, making it possible to rejoin the curvature of the zone A, and optimized to limit risks of backward fall, and to allow the possible integration of a braking system.

The skate according to the invention proposes a simple, technically reliable, financially balanced solution that provides more stability, comfort, and versatility of use.

It moves on a single rolling member that passes under, and approximately in the axis of the foot, the curvature of which in contact with the ground can have the optimum profile, and which takes up minimal space under the skater's foot.

The rolling member according to the invention makes it possible to develop different lines of rollers, more comfortable, more stable, safer and more versatile.

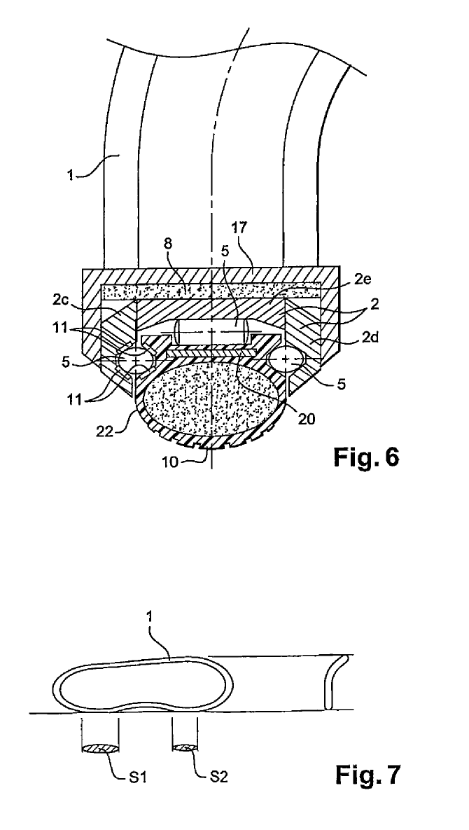

According to a third embodiment illustrated in FIG. 6, the rolling member shows the following alternatives:

The rolling elements 5 can be balls and rolls, and can be maintained by a cage comparable to that which equips the ball bearings, and having the necessary flexibility. The rollers can be cylindrical, or have any other revolution shape.

The shape of the raceways depends on the shape of the rolling elements, and the restrictions to be assumed.

The number of raceways depends on the usage criteria of the equipment.

The movement bead constitutes an elastic ring comprising, as in the embodiments previously described, a rolling strip 10, rolling surfaces 11.

Advantageously, a flexible center 20 is included in the movement bead 1, between the rolling surfaces 11 situated on either side of the bead so as to ensure the rigidity necessary for the transmission of guiding and maintenance stresses of the movement bead.

The flanks 22 of the bead reconcile good lateral strength and a good damping capacity. As before, the core 12 of the bead is made of a softer material, even a foam, or a void filled with a pressurized gas. The bead can also integrate an air chamber.

As before, the bead can perform other related functions: cavities on the concave side can allow the mechanical driving of related elements: braking, free wheel, motorization, or others.

The surface of the concave side can also be used as a braking drum. It is also possible to insert:

magnetic elements making it possible to generate electricity, or even to form a linear motor.

elements making it possible to measure movements, speed, pressure, and any other useful information.

The track guide 2 is connected to a vehicle by a connecting element 17 that houses the track guide 2.

The connecting element can have a U-shaped profile forming a housing for the track guide 2. A damping element 18 is advantageously arranged between the track guide and the bottom of the housing.

The track guide 2 is made in a single piece or in several parts 2c, 2d, 2e, machined or shaped depending on the desired displacement path meeting the usage.

A single track guide can support all of the rolling surfaces, but these can also be distributed on several track guides. Their number is not limited; it depends on the use.

Each track guide portion includes one or several integrated or attached rolling surfaces on which the rolling elements 5 will roll. These surfaces can belong to attached, glued, embedded, overmolded or other elements, or be formed in the track guide. The harder they are, the lower the rolling stress will be.

The track guide ensures, via rolling elements, the lateral, axial and radial guiding of the rolling bead, and the transmission of the stresses. In the case of partial guiding, a recycling circuit of the rolling elements will be integrated.

The single track guide, or all of the track guide portions, constitutes the annular hub of the flexible wheel.

The hub can include complementary elements, in particular for the fastening and maintenance of the track guide portion(s) 2, and for connection to the vehicle. It can include several zones, rigid or more or less flexible, depending on the restrictions supported by the considered path portion, and the functions to be performed: zone for transmitting stresses to the ground, zone for connection to the vehicle, zone for connection to the suspension, deformation zone, etc.

As needed, and depending on the zones of the path, the track guide portions can be integrated into an ad hoc cavity of the vehicle, rigidly, or elastically or guided by supports connected to or hinged on the vehicle, rigidly, or elastically. These track guide portions can be restricted in any other way or completely free.

The track guide 2 forms an annular hub that can be flexible.

According to an alternative shown in FIG. 7, the track guide 2 is arranged such that the bead has several distinct contact zones with a displacement surface, for example the ground.

The rolling member according to the invention can apply to individual leisure, movement or transportation equipment: skateboard, wheelchair, stroller, wheelbarrow, luggage, etc. . . or equip many types of moving equipment and vehicles.

Moreover, it is possible to attach suspension elements, a braking system, a backstop system, that can be disconnected if possible, a motorization, and other functionalities or accessories to it.

1. A rolling member:
a track guide, and
a moving part able to move relative to the track guide and designed to form a rolling strip traveling in a closed circuit,
the moving part constitutes a flexible and continuous movement bead, and the track guide is designed to guide the moving part along a skew path of variable curvature.

2. The member according to claim 1, also comprising revolution rolling elements arranged between a rolling surface of the moving part and the track guide so as to facilitate relative movement between the track guide and the moving part.

3. The member according to,
wherein the track guide includes one or several flexible parts.

4. The member according,
wherein the bead can have, inside, a core a softer material or a void filled with a pressurized gas.

5. The member according to,
wherein the bead is an assembly of several elements made up of different attached materials in order to obtain different mechanical properties for the rolling strip, the rolling surface and the core, as well as the elastic flexibility necessary for it.

6. The member according to,
wherein the bead has cavities facing inside of the path designed to cooperate with means designed to compel the movement in a single direction.

7. The member according to,
comprising braking means cooperating with the movement bead

8. The member according to,
wherein the bead comprises at least two rolling surfaces between which a flexible center is arranged so as to provide necessary rigidity for transmission of guiding and strength stresses of the movement bead.

9. The member according to,
wherein the track guide includes raceways making it possible to guide the movement of the rolling element, the movement bead comprises a rolling surface, the rolling elements being housed between the rolling surface of the movement bead and the raceway.

10. The member according to,
wherein the rolling elements comprise at least one roller whereof the axis of rotation is integral with the track guide, the movement bead comprising a rolling surface on which the rolling elements bear.

11. The member according to,
wherein the track guide is arranged such that the bead has several distinct contact zones with a movement surface.

12. An equipment or an individual movement, athletic or leisure skate comprising a rolling member according to.

13. The equipment according to claim 12, equipped with a footrest plate, designed to receive both feet of skater, who uses as a skateboard, snowboard or surfboard.

14. An equipment to allow or facilitate movement of people or goods comprising a rolling member according to.

15. A land, air or sea vehicle comprising a rolling member according to one.
